(19) United States
(12) Patent Application Publication
(10) Pub. No.: US 2025/0128265 A1
(43) Pub. Date: Apr. 24, 2025

(54) SHAFT COUPLING AND COMMINUTING DEVICE HAVING SUCH A SHAFT COUPLING

(71) Applicant: Manuel Lindner, Spittal/Drau (AT)

(72) Inventors: Manuel Lindner, Spittal/Drau (AT); Peter Weingartner, Dölsach (AT)

(73) Assignee: Manuel Lindner, Spittal/Drau (AT)

(21) Appl. No.: 18/696,285

(22) PCT Filed: Jun. 17, 2022
(86) PCT No.: PCT/EP2022/066545

§ 371 Date: Mar. 27, 2024

(30) Foreign Application Priority Data
Sep. 27, 2021 (EP) 21199036.1

(51) Int. Cl. B02C 18/24; B02C 18/08; F16B 7/04

(52) U.S. Cl. CPC B02C 18/24; B02C 18/08; F16B 7/0406

(57) ABSTRACT

The present invention relates to a shaft coupling device (10) and to a comminuting device having such a shaft coupling device (10). The shaft coupling device (10) has a first shaft hub (11) of a first shaft, the first shaft hub (11) having a plurality of first receiving units, a second shaft hub (14) of a second shaft, the second shaft hub (14) having a plurality of second receiving units, and a plurality of connection elements (12) for connecting the first shaft hub (11) to the second shaft hub (14). The plurality of first receiving units are arranged at a distance from each other along the circumference of the first shaft hub (11), and the plurality of second receiving units are arranged at a distance from each other along the circumference of the second shaft hub (14). The connection elements (12) are secured preferably in the recesses of the first shaft hub (11) by means of screws (13).

### FIELD OF THE INVENTION

The present invention relates to a shaft coupling device and, in particular, to a shaft coupling device for connecting a drive shaft of a comminuting device for comminuting material, in particular in the form of waste products, to a rotor shaft of the comminuting device. The present invention further relates to a comminuting device having such a shaft coupling device.

### PRIOR ART

In many technical areas, shafts, for example drive shafts and driven shafts, are connected to each other via couplings, such as constant velocity joints. The drive shaft is rotated by a motor and this rotation is transmitted to the driven shaft by the coupling. The couplings are generally configured and connected to the shafts such that they can be released. For example, maintenance or a necessary replacement of the driven shaft may require the coupling to be released in this way. Releasing the coupling is generally a relatively time-consuming and laborious mechanical process. For example, it is conventionally necessary to move the drive shaft or the driven shaft (typically the latter) axially to disengage the coupling. This can be relatively time-consuming and laborious, particularly in the case of heavy machines such as comminutors for comminuting industrial waste.

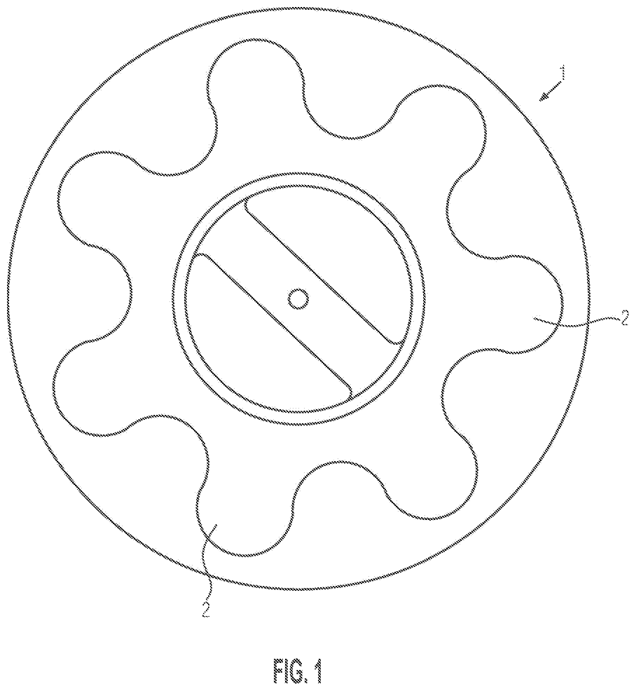

Commercial waste, industrial waste, household waste, etc., e.g. (hard) plastic, textiles, composites, rubber or waste wood (such as pallets and chipboard), require comminution before their final disposal or, in particular, before being returned to the recycling cycle. Single or multi-shaft comminutors are typically used for comminution, which are fed by wheel loaders, forklift trucks or conveyor belts via a hopper to feed the material. The comminution of the fed material takes place between knives rotating with a rotor shaft (comminution shaft) and stationary, i.e. non-rotating, counter knives (stator knives, scraper combs). The rotor shaft is driven by a drive shaft that is connected to it via a coupling. FIG. 1 shows an example of a cloverleaf coupling 1 of the prior art in cross-section. Corresponding geometrically matching end regions of a rotor shaft are fitted into the cloverleaf-shaped recesses 2 so that the coupling connects the rotor shaft to an opposing drive shaft. A rotor shaft of a comminutor can, for example, have a weight in the range of about one to about four tons. Axial displacement of the rotor shaft to release the coupling that connects the rotor shaft to the drive shaft is therefore a complex process.

In view of the aforementioned problems, it is therefore an object underlying the present invention to provide an improved coupling device, in particular for a comminuting device, the release of which can be facilitated in that this release does not require axial displacement of the shafts coupled to one another by the coupling device.

### DESCRIPTION

The above problem is solved by a shaft coupling device (a shaft coupling system) according to claim 1, comprising:
a first shaft hub of a first shaft, the first shaft hub having a plurality of first receiving units;
a second shaft hub of a second shaft, the second shaft hub having a plurality of second receiving units; and
a plurality of connection elements for (directly) connecting the first and second shaft hubs to each other; and wherein
the plurality of first receiving units are configured to be arranged, in particular exclusively, at a distance from each other along the circumference of the first shaft hub, and the plurality of second receiving units are configured to be arranged, in particular exclusively, at a distance from each other along the circumference of the second shaft hub.

The distances between the first receiving units along the circumference of the first shaft hub and between the second receiving units along the circumference of the second shaft hub can in principle be regular or irregular, wherein the distances in the first shaft hub correspond to those in the second shaft hub.

The shaft coupling device according to the invention and thus the coupled shafts can be released from each other without any axial displacement of the shafts connected to each other by the shaft coupling device. Particularly in the case of relatively heavy shafts (for example with weights in the range of one or more tons) and tight installation spaces, the shaft coupling device according to the invention therefore permits a lighter and faster solution for the coupling connection of two shafts (for example a drive shaft and a drivable/driven shaft) compared to the prior art.

In particular, the plurality of first receiving units can be configured as first recesses along the circumference of the first shaft hub, and correspondingly, the plurality of second receiving units can be configured as second recesses along the circumference of the second shaft hub, wherein the positions of the recesses in the first shaft hub correspond to the positions of the recesses in the second shaft hub. In this case, the recesses do not extend through the entire diameter of the shaft hubs. The first recesses may, for example, have a depth of ¼ to ⅔ of the radius of the first shaft hub, and the second recesses may, for example, have a depth of ¼ to ⅔ of the radius of the second shaft hub. The first recesses may or may not have a depth that is different from that of the second recesses. In addition, not all first recesses need to have the same depth, and not all second recesses need to have the same depth.

The plurality of first or second receiving units can be configured such that the plurality of connection elements can be releasably fitted into the plurality of first and/or second receiving units with play, for example in order to compensate for axial errors or angular errors between the axes of the shafts to be coupled. In particular, an elastic material (for example a silicone material) can be provided in the said first and/or second recesses, for example in order to dampen vibrations.

According to a further embodiment, the first and second receiving units are configured such that the plurality of connection elements can be inserted into these first and second receiving units exclusively in the radial direction of movement, so that they can also be released from receiving units and thus from the first and second shaft hubs exclusively in the radial direction of movement. The radial direction of movement is a direction of movement of the connection elements perpendicular to a longitudinal axis, which runs through the first or second shaft hub (and thus through the first or second shaft). In this context, the term “exclusively in the radial direction” is intended to mean that, in principle, there may be a small finite angle between the longitudinal axis running through the first shaft hub and first shaft and the longitudinal axis running through the second shaft hub and second shaft due to the manufacturing/arrangement. In the inserted/fitted state, the connection elements can be oriented parallel to the longitudinal axis.

According to this further embodiment, the connection elements are therefore moved perpendicular to the longitudinal axis to connect the shafts (shaft hubs) to each other and to disconnect the shafts (shaft hubs) from each other without axially displacing one of the shafts (shaft hubs). After releasing the connection elements, one of the shafts can be moved perpendicular to the longitudinal axis for maintenance or replacement.

Each of the plurality of connection elements may be adapted to fit into both one of the plurality of first receiving units and one of the plurality of second receiving units.

The first shaft hub and the second shaft hub can be rotationally symmetrical, in particular circular, in accordance with the geometric shape of typical shafts.

The plurality of connection elements can be cuboid in shape, wherein corners and/or edges and/or surfaces of the cuboids can be rounded. Such connection elements can be manufactured cost-effectively and reliably, for example from a steel material. Other geometric shapes, for example round shapes, of the connection elements can be selected as an alternative. However, the influence of the exact geometric shape on the functionality of the connection elements is relatively small.

The shaft coupling device may comprise a fastening means configured to secure the plurality of connection elements in the plurality of first receiving units and/or the plurality of second receiving units.

The fastening means for securing the connection elements in the receiving units can, for example, only be attached to one of the two shaft hubs. The fastening means can comprise screws and/or a ring flange. By means of screws or a ring flange, a quick and reliable securing of the connection elements in the receiving units and thus the coupled state can be achieved. The fastening means must be releasable to allow disengagement of the shaft coupling device. If the fastening means comprises screws, at least some of the connection elements may comprise threads or unthreaded passages configured to receive the screws, and the first shaft hub and/or the second shaft hub may comprise threads that are also configured to receive the screws.

Axial errors or angular errors between the axes of the shafts to be coupled can be compensated for if the plurality of first or second receiving units are configured such that the plurality of connection elements can be releasably fitted into the plurality of first or second receiving units with play. As soon as a torque is transmitted to one of the shafts, the shafts are firmly coupled to each other despite the play provided.

There is further provided a comminuting device comprising a material receiving space, a first shaft and a second shaft, and a shaft coupling device according to one of the examples described above for connecting the drive shaft to the rotor shaft. The first shaft may be a drive shaft and the second shaft may be a rotor shaft arranged in the material receiving space. Other shafts of the comminuting device may alternatively or additionally be connected to each other via a shaft coupling device according to the invention. The examples of the shaft coupling device according to the invention described above can be used in a preferred manner for relatively large and heavy comminuting devices for comminuting, for example, wood, plastic or textile waste products or other industrial, agricultural and domestic waste with weights in the ton range. It is understood that the comminuting device according to the invention comprises both single-shaft and multi-shaft comminutors and, in particular, vertical comminutors. The rotor shaft of such comminuting devices must be replaced after a certain period of operation and the decoupling process required for this from the drive shaft is conventionally laborious and time-consuming. The use of the shaft coupling device according to the invention facilitates the decoupling process, since the rotor shaft to be replaced does not have to be moved axially.

In the case of a twin-shaft comminutor in which two independent shafts operate, the shaft coupling device according to the invention can, for example, only be used for one of the two shafts.

Furthermore, a method for coupling a first shaft to a second shaft is provided with the steps below following one another in the order mentioned:
providing the first shaft with a first shaft hub having a plurality of first receiving units which are configured, in particular exclusively, at a distance from each other along the circumference of the first shaft hub;
providing the second shaft with a second shaft hub having a plurality of second receiving units which are configured, in particular exclusively, at a distance from each other along the circumference of the second shaft hub; and
fitting a plurality of connection elements into the plurality of first receiving units of the first shaft hub and the plurality of second receiving units of the second shaft hub, in particular exclusively in the radial direction of movement.

The plurality of connection elements can then be secured in the plurality of first receiving units and/or the plurality of second receiving units using a fastening means.

In the coupled state, that is, after fitting the connection elements and securing them with the fastening means, the first and second shaft hubs can contact each other (be in abutment with each other), or a space can remain between the first and second shaft hubs.

Accordingly, there is provided a method for uncoupling a first shaft from a second shaft connected to each other via a shaft coupling device according to one of the examples described above, comprising the steps below following one another in the order mentioned:
releasing the plurality of connection elements of the shaft coupling device, in particular by moving the plurality of connection elements exclusively radially away from the first shaft hub of the first shaft and the second shaft hub of the second shaft; and
displacing the first shaft relative to the second shaft exclusively in a direction perpendicular to the longitudinal direction of the second shaft (of the two shafts).

Before releasing the plurality of connection elements, a fastening means of the shaft coupling device, which may be provided to secure the connection elements, may be released.

Further features and exemplary embodiments of the present invention are explained in more detail below with reference to the drawing. It is understood that the embodiments do not exhaust the scope of the present invention. It is further understood that some or all of the features described below may also be combined in other ways.

FIG. 1 shows a cloverleaf coupling according to the prior art.

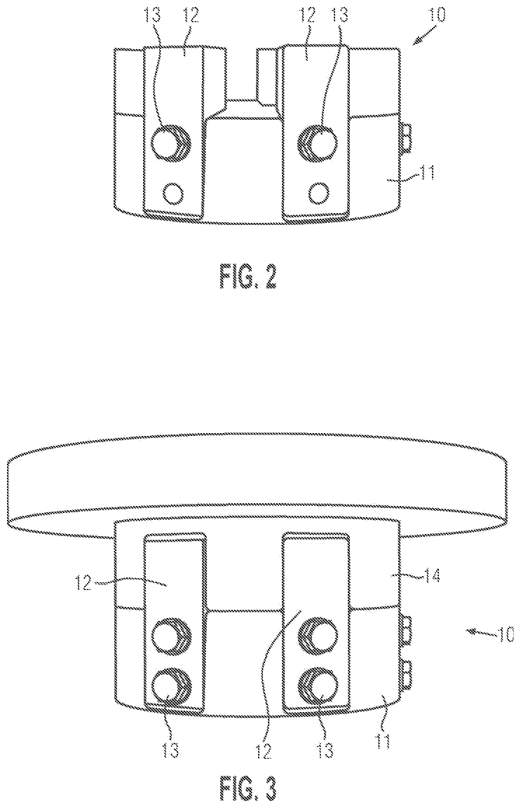

FIG. 2 shows a part of a shaft coupling device according to an embodiment of the present invention in a released state.

FIG. 3 shows a shaft coupling device according to one embodiment of the present invention in a coupled state.

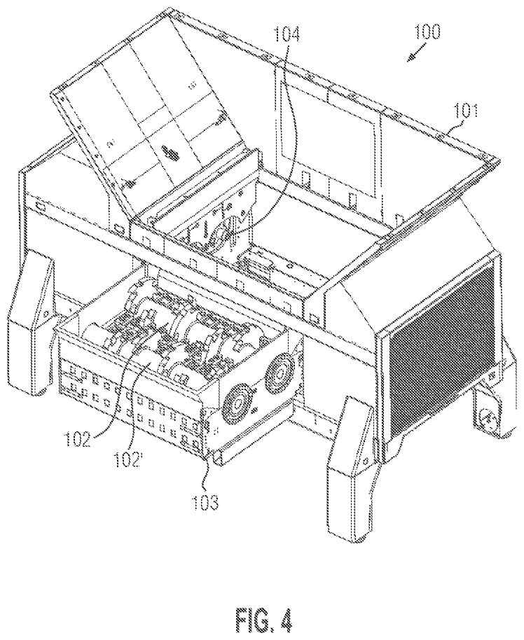

FIG. 4 shows a comminuting device in which the shaft coupling device according to the invention can be used.

The present invention provides a shaft coupling device which couples (connects) two shafts together for the transmission of torques. The shaft coupling device is configured such that neither of the two shafts has to be moved axially when the shafts are uncoupled, which simplifies, for example, the replacement of one of the shafts.

FIG. 2 shows a part of a shaft coupling device 10 (an open coupling) according to an embodiment of the present invention. The shaft coupling device 10 comprises a first shaft hub 11 of a first shaft (for example, a drive shaft or drivable shaft). Furthermore, the shaft coupling device 10 comprises a plurality of cuboid connection elements 12 which, in the embodiment shown, are fitted into receiving units in the form of recesses (the receiving units or recesses are concealed in FIG. 2 by the fitted connection elements 12). The recesses (and thus the cuboid connection elements 12) are arranged at a distance from each other along the circumference of the first shaft hub 11.

The connection elements 12 are secured in the recesses of the first shaft hub 11 by screws 13. Other fastening means, such as a ring flange, can be used alternatively or additionally. Each of the plurality of connection elements 12 can be secured in the recesses by one or more screws. For this purpose, corresponding threads are provided in the recesses of the first shaft hub 11. The screws 13 can be guided through threads or threadless passages in the connection elements 12. The first shaft hub and the connection elements 12 can be made of or comprise a metal material, such as steel, and the recesses can be milled into the first shaft hub 11. Due to the arrangement and formation of the recesses, the connection elements 12 can be fitted into or removed from the recesses of the first shaft hub 11 exclusively in a radial direction of movement.

FIG. 3 shows a coupled state of two shafts (shaft coupling device 10 closed). In this case, the connection elements 12 are also fitted in corresponding recesses of a second shaft hub 14 of a second shaft (for example, a drive shaft or drivable shaft). Each of the connection elements 12 is fitted in one of the recesses of the first shaft hub 11 and one of the recesses of the second shaft hub 14. The connection elements 12 can also be fitted into the recesses of the second shaft hub 14 exclusively in a radial direction of movement or they can be removed from the recesses exclusively in a radial direction of movement. The fitted connection elements 12 are aligned parallel to a longitudinal axis running through the first and second shaft hubs 11, 14.

In the embodiment shown in FIG. 3, the screws 13 are only provided for fastening the connection elements 12 to the first shaft hub 11. In this way, the connection elements 12 can be fitted in particular in the recesses of the second shaft hub 14 with a certain amount of play, whereby axial errors or angular errors of the axes of the shafts in their alignment to one another can be compensated. In general, any play provided can, if desired, be filled with an elastic material, such as a silicone material.

The closed shaft coupling device 10 shown in FIG. 3 can be released as follows. First, the screws 13 are loosened. Then, the connection elements 12 of the shaft coupling device 10 can be released by moving them exclusively radially away from the first shaft hub 11 of the first shaft and the second shaft hub 14 of the second shaft. After removing the connection elements 12, one of the shafts can be moved relative to the other shaft exclusively in a direction perpendicular to the longitudinal direction of the two shafts and, for example, maintained or replaced.

A replacement of a shaft coupled to another shaft by the shaft coupling device 10 according to the invention can therefore be carried out without a radial movement of one of the shafts. This is particularly preferred when replacing heavy shafts (for example with weights in the ton range), as heavy shafts are difficult to move in the longitudinal direction. A suitable use of the shaft coupling device 10 according to the invention is for the coupling of a drive shaft and a rotor shaft of a comminuting device for comminuting wood, plastic or textile waste products or other industrial, agricultural and household waste. An exemplary comminuting device 100 in the form of a twin-shaft comminutor is shown in FIG. 4.

According to one embodiment, the comminuting device 100 shown in FIG. 4 comprises the shaft coupling device 10. The comminuting device 100 comprises a material receiving space 101 into which material to be comminuted can be filled. For example, the material receiving space 101 can be fed with the material to be comminuted by wheel loaders, forklift trucks or conveyor belts via a hopper.

The material to be comminuted is comminuted by means of rotor shafts 102, 102′, which are equipped with knives. A pusher, not shown in FIG. 4, can be provided to push the material to be comminuted towards the rotor shafts 102, 102′. 1 n FIG. 4, these rotor shafts 102, 102′ are shown in a maintenance state and not in the operating state. 1 n the maintenance state, they are moved laterally out of the material receiving space 101 on a carrier cassette 103. The comminuting device 100 comprises a drive shaft for each of the two rotor shafts 102, 102′, the shaft hubs 104 of which can be positioned inside or outside the material receiving space 101. The shaft hub 104 can be the first shaft hub 11 shown in FIGS. 2 and 3 or the second shaft hub 14 shown in FIG. 3 or can be similar thereto.

Each of the two rotor shafts 102, 102′ also has a corresponding shaft hub, which may be similar to or the same as the first shaft hub 11 shown in FIGS. 2 and 3 or the second shaft hub 14 shown in FIG. 3. Due to the fact that the comminuting device 100 comprises the shaft coupling device according to the invention, for example the shaft coupling device 10 illustrated in FIGS. 2 and 3, for coupling the drive shafts and rotor shafts 102, 102′, the shaft coupling device can be released without an axial displacement of the rotor shafts 102, 102′. The fastening means and the connection elements can be released and removed and subsequently the cassette 103 with the rotor shafts 102, 102′ mounted thereon can be pushed out perpendicular to their axes for maintenance or replacement of one of the rotor shafts 102, 102′ or both rotor shafts 102, 102′.

1. Shaft coupling device (10) comprising
a first shaft hub (11) of a first shaft, the first shaft hub (11) having a plurality of first receiving units
a second shaft hub (14) of a second shaft, the second shaft hub (14) having a plurality of second receiving units
a plurality of connection elements (12) for connecting the first and second shaft hubs to each other; and wherein
the plurality of first receiving units are arranged at a distance from each other along the circumference of the first shaft hub, and the plurality of second receiving units are arranged at a distance from each other along the circumference of the second shaft hub.

2. Shaft coupling device (10) according to claim 1, in which the plurality of first receiving units are configured as first recesses along the circumference of the first shaft hub (11), and the plurality of second receiving units are configured as second recesses along the circumference of the second shaft hub (14).

3. Shaft coupling device (10) according to one of the preceding claims, wherein an elastic material is provided in the first and/or second recesses.

4. Shaft coupling device (10) according to one of the preceding claims, wherein the plurality of first and second receiving units are configured such that the plurality of connection elements (12) can be releasably fitted in an exclusively radial direction of movement and can be released from the first and second shaft hubs exclusively in a radial direction of movement.

5. Shaft coupling device (10) according to one of the preceding claims, wherein each of the plurality of connection elements (12) can be fitted into both one of the plurality of first receiving units and one of the plurality of second receiving units.

6. Shaft coupling device (10) according to one of the preceding claims, wherein the first shaft hub (11) and the second shaft hub (14) are rotationally symmetrical.

7. Shaft coupling device (10) according to one of the preceding claims, wherein the plurality of connection elements (12) are cuboidal in shape.

8. Shaft coupling device (10) according to one of the preceding claims, further comprising fastening means (13) configured to secure the plurality of connection elements (12) in the plurality of first receiving units and/or the plurality of second receiving units.

9. Shaft coupling device (10) according to claim 8, wherein the fastening means (13) comprises screws and/or a ring flange.

10. Shaft coupling device (10) according to claim 9, in which
the fastening means (13) comprises screws,
at least some of the connection elements (12) comprise threads or threadless passages which are configured to receive the screws, and
the first shaft hub (11) and/or the second shaft hub (14) comprise threads which are configured to receive the screws.

11. Shaft coupling device (10) according to one of the preceding claims, wherein the plurality of first or second receiving units are configured such that the plurality of connection elements (12) can be releasably fitted into the plurality of first or second receiving units with play.

12. Comminuting device (100) comprising:
a material receiving space (101);
a first shaft, in particular a drive shaft
a second shaft, in particular a rotor shaft (102, 102′) arranged in the material receiving space; and
a shaft coupling device (10) according to one of the preceding claims for connecting the drive shaft to the rotor shaft (102, 102′).

13. Comminuting device (100) according to claim 12, wherein the comminuting device (100) is a single-shaft or multi-shaft comminutor, in particular a vertical comminutor.

14. Method for coupling a first shaft to a second shaft, comprising the steps below following one another in the order mentioned:
providing the first shaft with a first shaft hub (11) having a plurality of first receiving units which are arranged at a distance from each other along the circumference of the first shaft hub (11);
providing the second shaft with a second shaft hub (14) having a plurality of second receiving units which are arranged at a distance from each other along the circumference of the second shaft hub (14); and
fitting a plurality of connection elements (12) into the plurality of first receiving units of the first shaft hub (11) and the plurality of second receiving units of the second shaft hub (14), in particular exclusively in the radial direction of movement.

15. Method for uncoupling a first shaft from a second shaft, which are connected to each other via a shaft coupling device (10) according to one of claims 1 to 11, comprising the steps below, following one another in the order mentioned:
releasing the plurality of connection elements (12) of the shaft coupling device (10), in particular by moving the plurality of connection elements (12) exclusively radially away from the first shaft hub (11) of the first shaft and the second shaft hub (14) of the second shaft; and
displacing the first shaft relative to the second shaft exclusively in a direction perpendicular to the longitudinal direction of the second shaft.
